(19) United States
(12) Patent Application Publication
(10) Pub. No.: US 2022/0018574 A1
(43) Pub. Date: Jan. 20, 2022

(54) HEATER UNIT, INK SUPPLY DEVICE AND IMAGE FORMING SYSTEM

(71) Applicant: KYOCERA Document Solutions Inc., Osaka (JP)

(72) Inventors: Yasutaka Inui, Osaka-shi (JP); Noriaki Furukawa, Osaka-shi (JP); Yuko Yano, Osaka-shi (JP); Sho Harabe, Osaka-shi (JP); Yuzo Onishi, Osaka-shi (JP); Tetsuya Ueno, Osaka-shi (JP); Shunsuke Yamasaki, Osaka-shi (JP)

(73) Assignee: KYOCERA Document Solutions Inc., Osaka (JP)

(21) Appl. No.: 17/373,202

(22) Filed: Jul. 12, 2021

(30) Foreign Application Priority Data
Jul. 16, 2020 (JP) 2020-122286

(51) Int. Cl. F24H 1/10; H05B 1/02; G05D 23/19; B41J 2/175

(52) U.S. Cl. CPC F24H 1/102; H05B 1/0244; H05B 2203/021; B41J 2/175; H05B 2203/005; G05D 23/1927

(57) ABSTRACT

A heater unit includes a metal plate, a pipe and a linear heater. The pipe comes into contact with one surface of the metal plate, and a fluid to be heated is passed through the pipe. The linear heater comes into contact with the other surface of the metal plate and is disposed along the pipe.

### INCORPORATION BY REFERENCE

This application is based on and claims the benefit of priority from Japanese patent application No. 2020-122286 filed on Jul. 16, 2020, which is incorporated by reference in its entirety.

### BACKGROUND

The present disclosure relates to a heater unit which heats a fluid, an ink supply device and an image forming system including the heater unit.

An ink jet recording device includes an ink container which supplies an ink to a recording head. On the assumption that a large amount of the ink is consumed, an ink jet supply device including a large capacity ink container is provided.

In order to achieve excellent image quality, it is necessary to keep a viscosity of the ink within an appropriate range. But, in a case of low room temperature, a viscosity of the ink may increase. Therefore, the ink supply device includes a heater which heats the ink. For example, the ink supply device may be configured such that an ink pipe is stored in a groove formed in a metal block and the ink is heated via the block. Or, the ink supply device may be configured such that an ink path is formed by bonding a metal plate having a groove and a lid, and the ink is heated via the lid.

However, in a case where the ink is heated via the block, a heat capacity may increase. In a case where the ink is heated via the lid, there is a possibility that the ink is leaked through a gap between the metal plate and the lid. In order to avoid the above problems, a linear heater main be disposed along the pipe. However, it is difficult to make a distance between the heater and the pipe constant, and a heat conductivity from the heater to the pipe may not be constant.

### SUMMARY

In accordance with an aspect of the present disclosure, a heater unit includes a metal plate, a pipe and a linear heater. The pipe comes into contact with one surface of the metal plate, and a fluid to be heated is passed through the pipe. The linear heater comes into contact with the other surface of the metal plate and is disposed along the pipe.

In accordance with an aspect of the present disclosure, an ink supply device includes an ink container in which an ink is stored and the heater unit which heats the ink fed from the ink container.

In accordance with an aspect of the present disclosure, an image forming system includes the ink supply device and an inkjet recording apparatus which discharges the ink fed from the ink supply device and forms an image.

The other features and advantages of the present disclosure will become more apparent from the following description. In the detailed description, reference is made to the accompanying drawings, and preferred embodiments of the present disclosure are shown by way of example in the accompanying drawings.

### BRIEF DESCRIPTION OF THE DRAWINGS

FIG. 1 is a perspective view showing an exterior appearance of an ink supply device and a printer according to one embodiment of the present disclosure.

FIG. 2 is a front view schematically showing an inner structure of the printer according to the embodiment of the present disclosure.

FIG. 3 is a view schematically showing an ink supply path according to one embodiment of the present disclosure.

FIG. 4 is a perspective view showing an inner structure of the ink supply device according to the embodiment of the present disclosure.

FIG. 5A is a perspective view showing a heater unit according to the embodiment of the present disclosure.

FIG. 5B is a perspective view showing the heater unit according to the embodiment of the present disclosure.

FIG. 6A is a perspective view showing an inside (a heater) of the heater unit according to the embodiment of the present disclosure.

FIG. 6B is a perspective view showing the inside (a pipe) of the heater unit according to the embodiment of the present disclosure.

FIG. 7 is a sectional view showing the heater unit according to the embodiment of the present disclosure.

FIG. 8 is a sectional view showing a second section of the heater unit according to the embodiment of the present disclosure.

FIG. 9 is a front view showing the pipe according to the embodiment of the present disclosure.

FIG. 10 is a front view showing the pipe and a metal plate according to the embodiment of the present disclosure.

FIG. 11 is a plan view showing a first contact area and a second contact area according to the embodiment of the present disclosure.

FIG. 12 is a sectional view schematically showing the heater unit according to the embodiment of the present disclosure.

FIG. 13 is a block diagram showing an electric structure of the ink supply device according to the embodiment of the present disclosure.

### DETAILED DESCRIPTION

Hereinafter, with reference to the attached drawings, an image forming system 3 according to one embodiment of the present disclosure will be described.

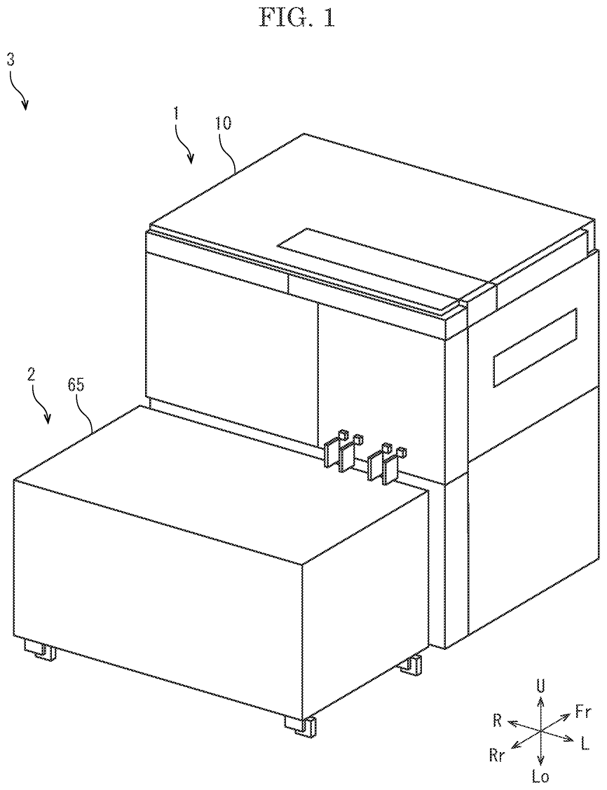

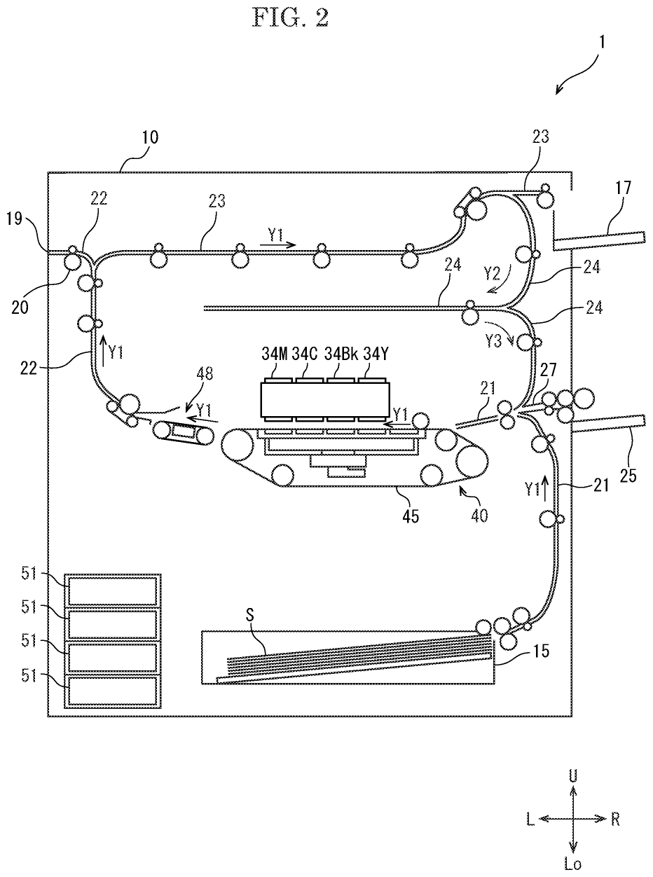

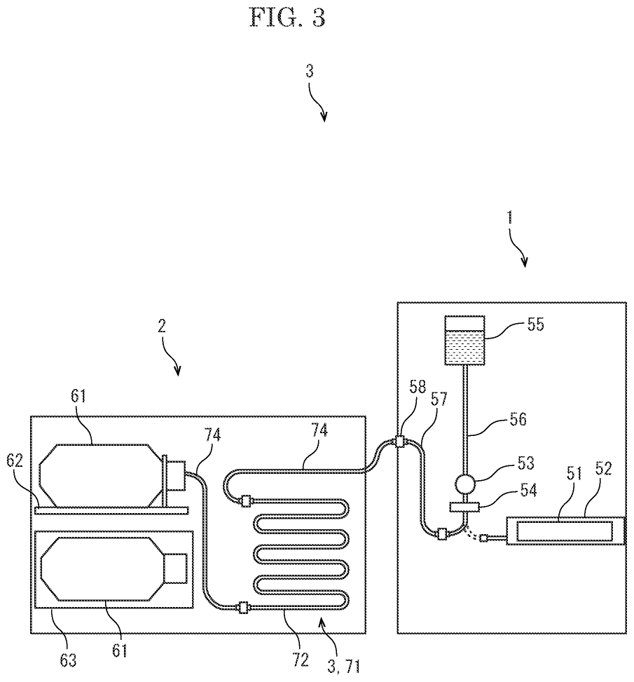

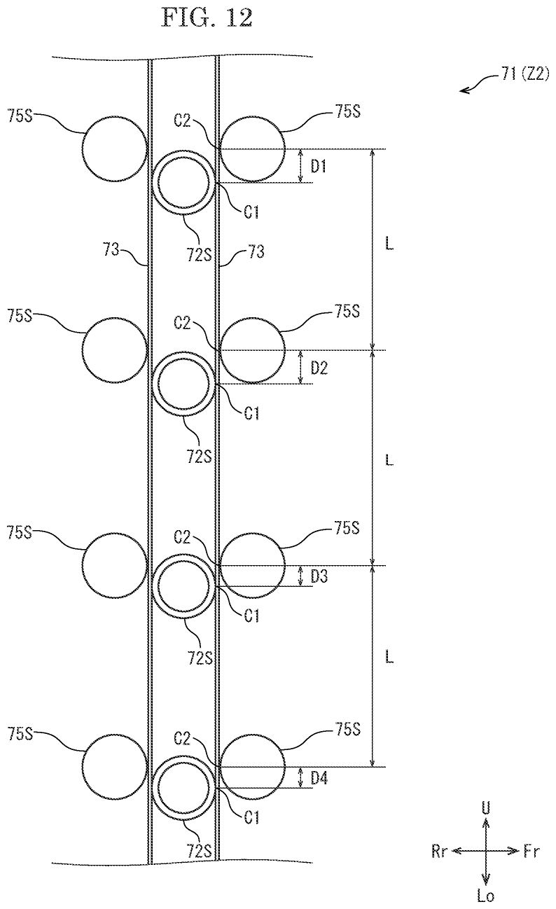

First, an entire structure of the image forming system 3 will be described. The image forming system 3 includes an ink supply device 2 and a printer 1 (an example of an inkjet recording apparatus). FIG. 1 is a perspective view showing an exterior appearance of the ink supply device 2 and the printer 1. FIG. 2 is a front view schematically showing an inner structure of the printer 1. FIG. 3 is a view schematically showing an ink supply path. Hereinafter, a Fr side in FIG. 1 (a front side on a paper surface on which FIG. 12 is drawn) is defined as a front side of the ink supply device 2 and the printer 1, and a left side and a right side are based on a direction in which the ink supply device 2 and the printer 1 are viewed from the front side. U, Lo, L, R, Fr and Rr marked in each figure indicate an upper, a lower, a left, a right, a front and a rear.

The printer 1 is an inkjet type image forming apparatus which forms an image by discharging an ink on a sheet S (an example of a sheet shaped recording medium), such as a plain paper and a coated paper. The ink supply device 2 is disposed on the rear side of the printer 1, and supplies the ink to the printer 1.

The printer 1 includes a box-shaped housing 10 in which various devices are stored. A sheet feeding cassette 15 in which the sheet S is stored is provided in the lower portion of the inside of the housing 10 in a drawable manner, and a manual sheet feeding tray 25 on which the sheet S is manually set is provided on the right side surface of the housing 10. Above the manual sheet feeding tray 25, a sheet discharge tray 17 on which the image-formed sheet S is stacked is provided. In the upper portion of the left side surface of the housing 10, a discharge port 19 through which the sheet S is conveyed to a post-processing apparatus (not shown) disposed on the left side of the printer 1 is formed.

In the central portion of the inside of the housing 10, head units 34Y, 34Bk, 34C and 34M (hereinafter, called a head unit 34) provided with one or more inkjet heads discharging the ink on the sheet S are provided, and discharge the inks of yellow, a black, cyan and magenta, respectively. Below the head units 34, a conveyance unit 40 which attracts the sheet S on which the image is formed to a conveyance belt 45 and then conveys it is provided. On the left side of the conveyance unit 40, a drying unit 48 which dries the image-formed sheet S while conveying it is provided. In the lower left portion of the inside of the housing 10, ink containers 51 storing the ink are stored.

A first conveyance path 21 from the sheet feeding cassette 15 to the conveyance unit 40 and a manual sheet conveyance path 27 joining from the manual sheet feeding tray 25 to the first conveyance path 21 are provided on the right side of the conveyance unit 40. A second conveying path 22 from the drying unit 48 to the discharge port 19 is provided on the left side of the drying unit 48. Above the head units 34, a third conveyance path 23 branching from the second conveyance path 22 to the sheet discharge tray 17, and a fourth conveyance path 24 branching from the third conveyance path 23 and joining to the first conveyance path 21 are provided. At a branch point between the second conveyance path 22 and the third conveyance path 23 and at a branch point between the third conveyance path 23 and the fourth conveyance path 24, a switching member for switching the conveying path of the sheet S is provided (not shown).

Next, an image forming processing performed by the printer 1 will be described. When an image forming job is input to the printer 1, the sheet S is fed from the sheet feeding cassette 15 or the manual sheet feeding tray 25 and conveyed in a Y1 direction along the first conveyance path 21. The sheet S is attracted to the conveyance belt 45 of the conveyance unit 40 and conveyed. Then, the head units 34 discharge the ink droplet to the sheet S, and form an image on the sheet S. The sheet S on which the image is formed is conveying by the drying unit 48 while promoting a drying of the ink, is conveyed along the second conveyance path 22 and the third conveyance path 34, and then is discharged on the discharge tray 17.

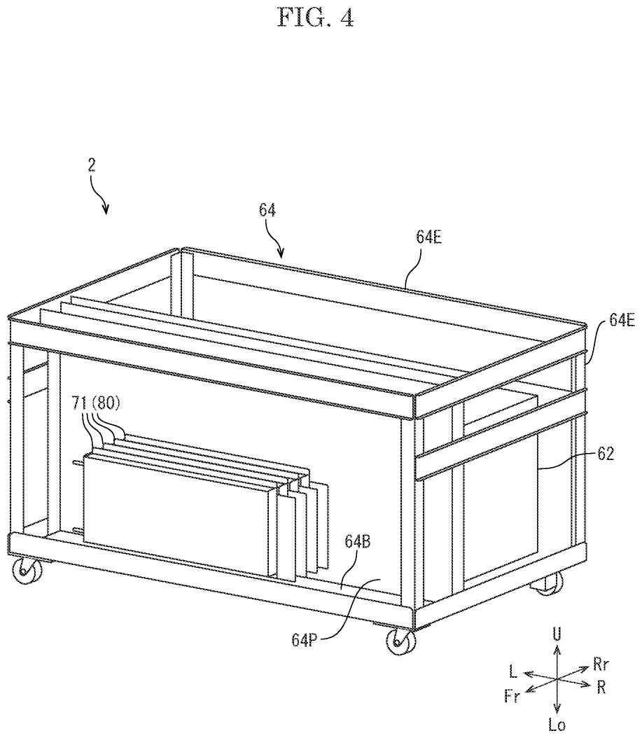

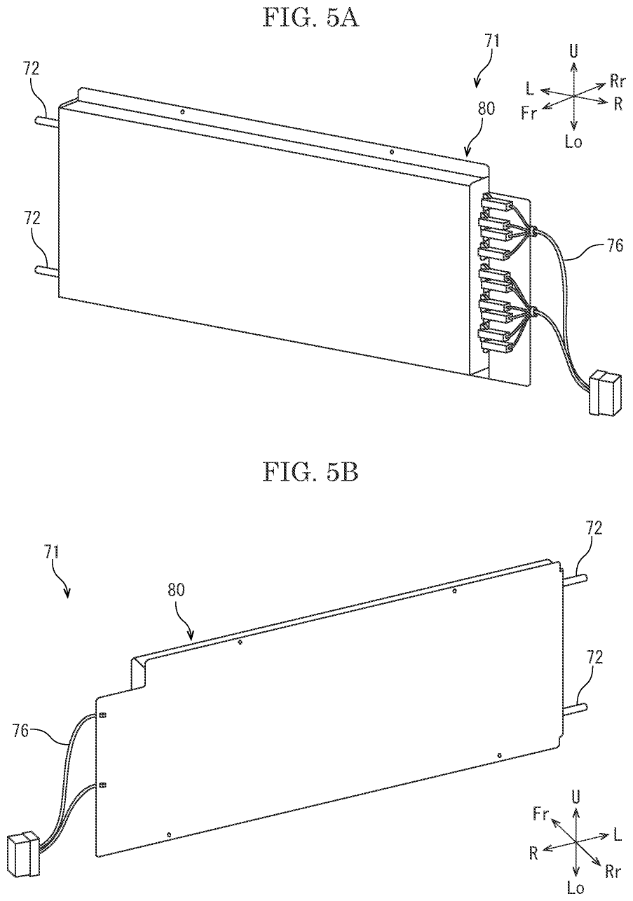

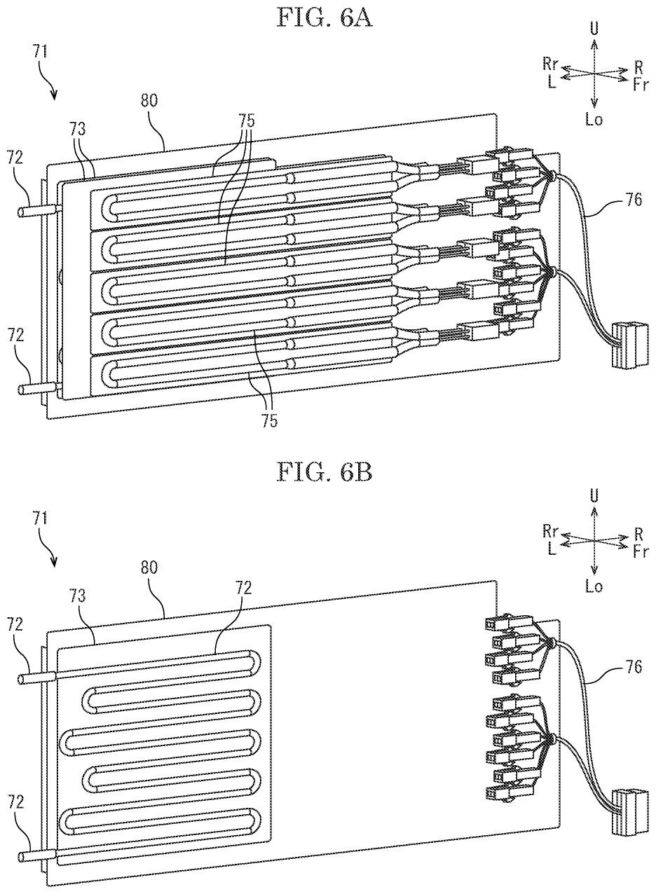

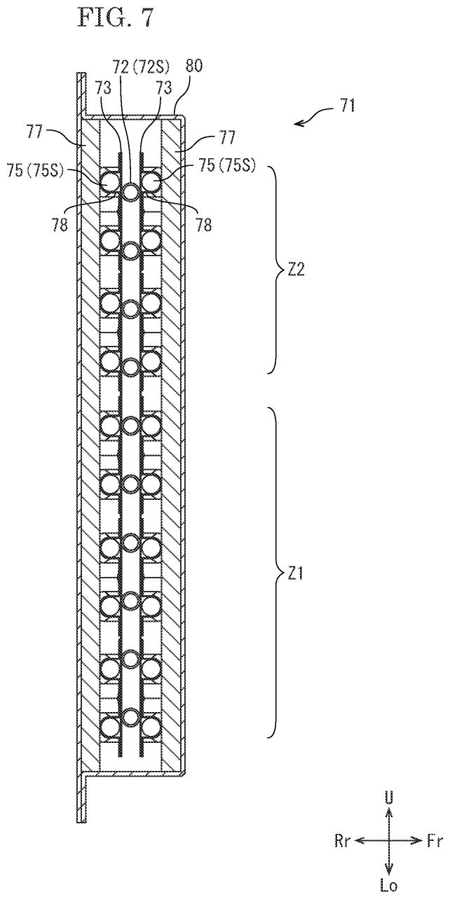

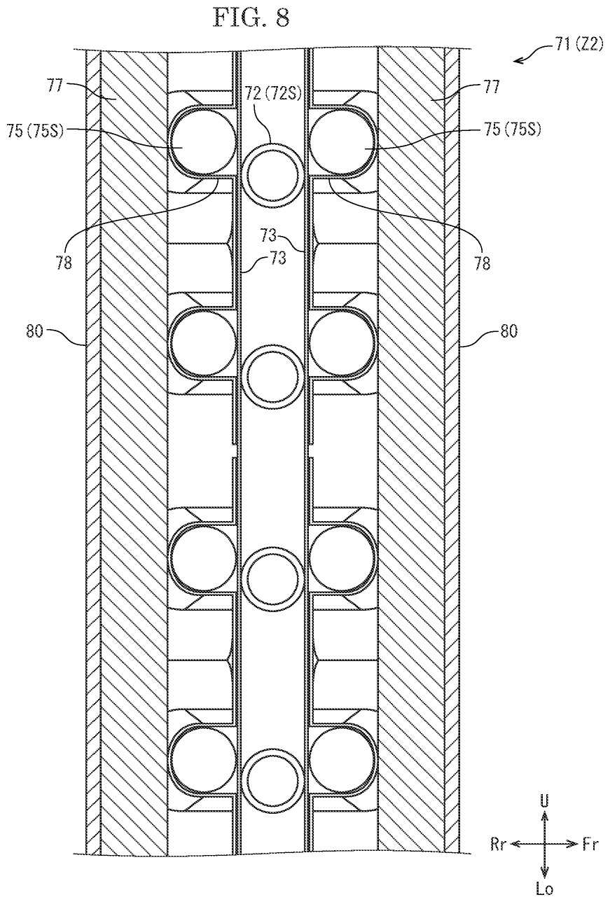

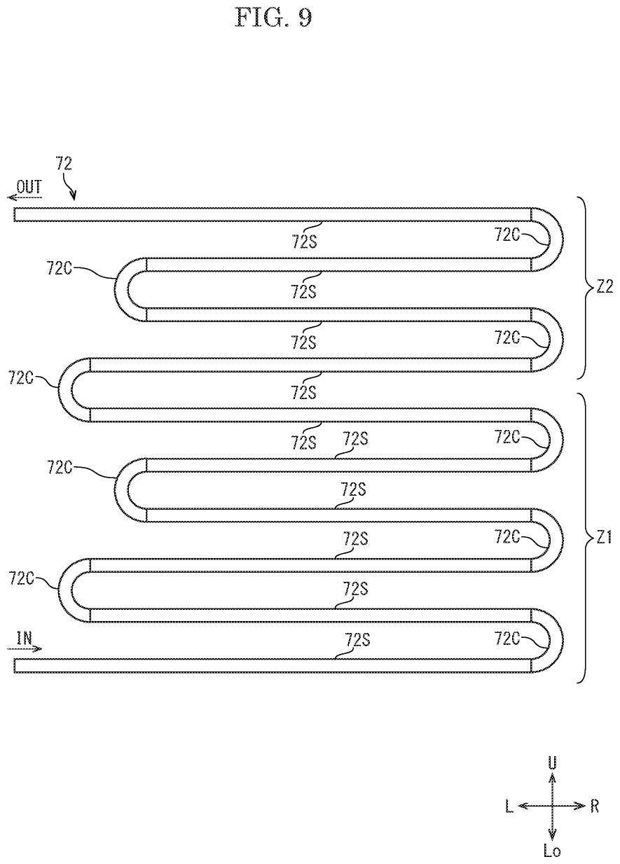

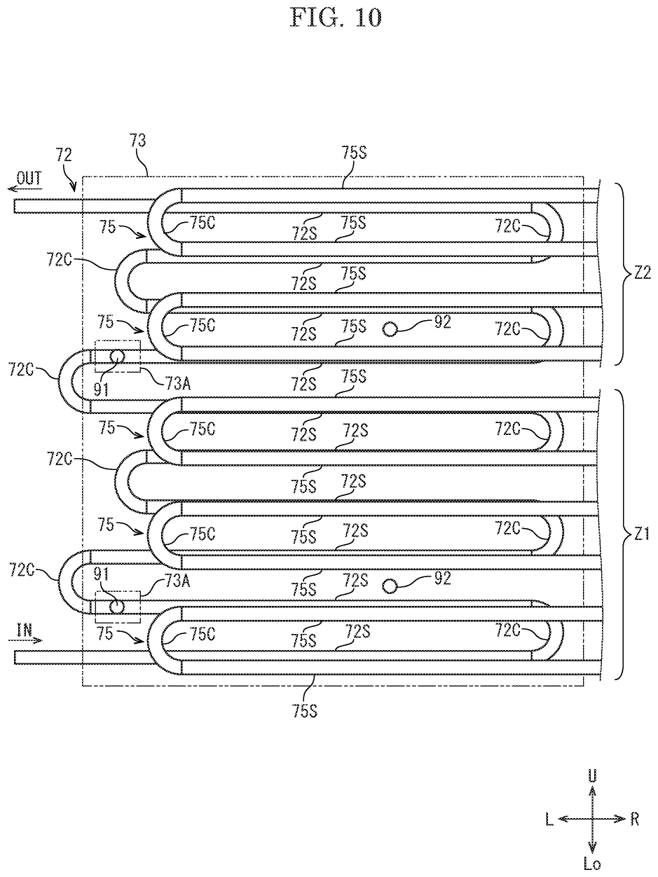

Next, the ink supply path will be described. FIG. 3 shows a configuration corresponding to one color of the ink. In this embodiment, the four colors of the ink are used, and the four similar configurations are provided. The printer 1 includes a container attachment part 52 to which an ink container 51 is attached; a pump 53 which sucks the ink from the ink container 51; a filter 54 which filters the ink sucked by the pump 53; a sub tank which stores the ink fed from the pump 53; and a pump (not shown) which feeds the ink stored in the sub tank 55 to the head unit 34. The ink container 51, the filter 54, the pump 53 and the sub tank 55 are connected by a main pipe 56. One end of a relay pipe 57 is connected to a coupling 58 provided on the back surface of the main body housing 10 of the printer 1. When the ink supply device 2 is used, the upstream end of the main pipe 36 is connected to the other end of the relay pipe 57 in place of the ink container 31.

[Ink Supply Device] Next, the ink supply device 2 will be described. FIG. 4 is a perspective view showing the inside of the ink supply device 2. FIG. 5A and FIG. 5B are perspective views showing a heater unit 71. FIG. 6A is a perspective view of the inside of the heater unit 71 (a heater 75). FIG. 6B is a perspective view showing the inside (a pipe 72) of the heater unit 71. FIG. 7 is a sectional view showing the heater unit 71. FIG. 8 is a sectional view showing the second section Z2 of the heater unit 71. FIG. 9 is a front view showing the pipe 72. FIG. 10 is a front view showing the pipe 72, a metal plate 73 and the heater 75.

The ink supply device 2 includes an ink container 61 which stored the ink and a heater unit 71 which heats the ink fed from the ink container 61.

[Frame] A frame 64 (see FIG. 4) has ridge portions 64E forming ridges of a rectangular parallelepiped, a bottom plate portion 64B forming a bottom of the rectangular parallelepiped, and a partition wall portion 64P partitioning the inner space of the rectangular parallelepiped into the front space and the rear space. By mounting side plates and a top plate outside the frame 64, a housing 65 (see FIG. 1) is formed. The four heater units 71 are disposed on the front side of the partition wall portion 64P, and the four ink containers 61 are disposed on the rear side of the partition wall portion 64P. The four heater units 71 are arranged in parallel in a front-and-rear direction, and are fixedly mounted to the frame 64.

[Ink Container] The ink supply device 2 (see FIG. 3, FIG. 4) includes a container attachment part 62 to which the ink container 61 is attached. The ink container 61 has a capacity larger than the ink container 51 attached to the inside of the printer 1. Because the inks of the four colors are used in the present embodiment, the four ink containers 61 filled with the inks of yellow, black, cyan and magenta are provided. A reserve container storage part 63 in which the reserve ink container 61 is attached may be provided.

[Heater Unit] The heater unit 71 is provided for each ink container 61. The heater unit 71 includes a metal plate 73, a pipe 72 coming into contact with the metal plate 73, and a linear heater 75 coming into contact with the metal plate 73 on an opposite side to the pipe 72 so as to be disposed along the pipe 72.

[Casing] A casing 80 (see FIG. 5A, FIG. 5B) is formed into a hollow plate-like shape having a size in the front-and-rear direction smaller than sizes in the left-and-right direction and in the upper-and-lower direction. The casing 80 stores the metal plate 73, the pipe 72 and the heater 75.

[Metal Plate] Inside the heater unit 71, the two metal plates 73 facing each other are provided (see FIG. 6A to FIG. 8). The metal plate 73 is a plate made of aluminum alloy or a copper alloy, and is fixedly mounted to the casing 80 at a plurality of positions of the end portion using screws (not shown). A formation of a gap between the pipe 72 and the heater 75, and the metal plate 73 due to bending deformation or torsional deformation of the metal plate 73 must be avoided because a heat conductivity is lowered. However, if the metal plate 73 is made too thick in order to suppress the deformation, a heat capacity may increase. In order to achieve both the suppression of the deformation and the suppression of the increasing of heat capacity, the metal plate 73 preferably has a thickness of 2 to 20%, more preferably 5 to 15% of a diameter of a circle having the same sectional area as the pipe 72. The thickness of the metal plate 73 is, for example, 0.1 to 2 mm, depending on the sectional area of the pipe 72.

[Pipe] The pipe 72 (see FIG. 6B to FIG. 9) is disposed between the two metal plate 72, and comes into contact with the two metal plates 73. The pipe 72 is made of stainless steel, for example. The pipe 72 has a plurality of pipe straight portions 72S formed into a straight shape and a plurality of pipe curved portions 72C bent into a U-shape and connecting the pipe straight portions 72S in series (see FIG. 9). In this embodiment, the ten pipe straight portions 72S are provided. The pipe straight portions 72S are disposed in parallel at equal intervals, and the whole pipe 72 is formed into a regularly meandered shape. The pipe 72 is fixedly mounted on the metal plate 73 at a plurality of positions using a bracket or an adhesive tape (not shown). The pipe 72 may have a circular section having a diameter of 1 to 20 mm, or may not have a circular section if it has the same sectional area.

The left lower end of the pipe 72 is fixedly mounted on the casing 80, and is connected to the ink container 61 through a relay pipe 74 (see FIG. 3). The left upper end of the pipe 72 is fixedly mounted on the casing 80, and is connected to the coupling 58 of the printer 1 through the relay pipe 74. The left lower end of the pipe 72 is an inlet port for the ink and the left upper end of the pipe 72 is an exit port for the ink. “IN” and “OUT” shown in FIG. 9 show a flow direction of the ink. The pipe 72 contains a first section Z1 and a second section Z2 (they are an example of a plurality of sections) divided along a flow direction of the ink (an example of a fluid). The first section Z1 is disposed on the upstream side in the flow direction and the second section Z2 is disposed on the downstream side in the flow direction.

[Heater] The heater unit 71 includes a plurality of the linear heater 75 coming into contact with the metal plate 73 on an opposite side to the pipe 72 with respect to each metal plate 73 and disposed along the pipe 72. The same numbers of the heaters 75 are disposed on the front side of the front metal plate 73 and on the rear side of the rear metal plate 73. In the embodiment, the five heaters 75 are disposed on the front side of the front metal plate 73, the five heaters 75 are disposed on the rear side of the rear metal plate 73, and a total of ten heaters 75 are provided. The second section Z2 is shorter than the first section Z1. Therefore, the number of the heaters 75 in the second section Z2 is smaller than the number of the heaters 75 in the first section Z1. In the embodiment, the three heaters 75 are respectively disposed on the front side and on the rear side in the first section Z1, and the two heaters 75 are respectively disposed on the front side and on the rear side in the second section Z2. Then, a total of six heaters 75 are disposed in the first section Z1 and a total of four heaters 75 are disposed in the second section Z2.

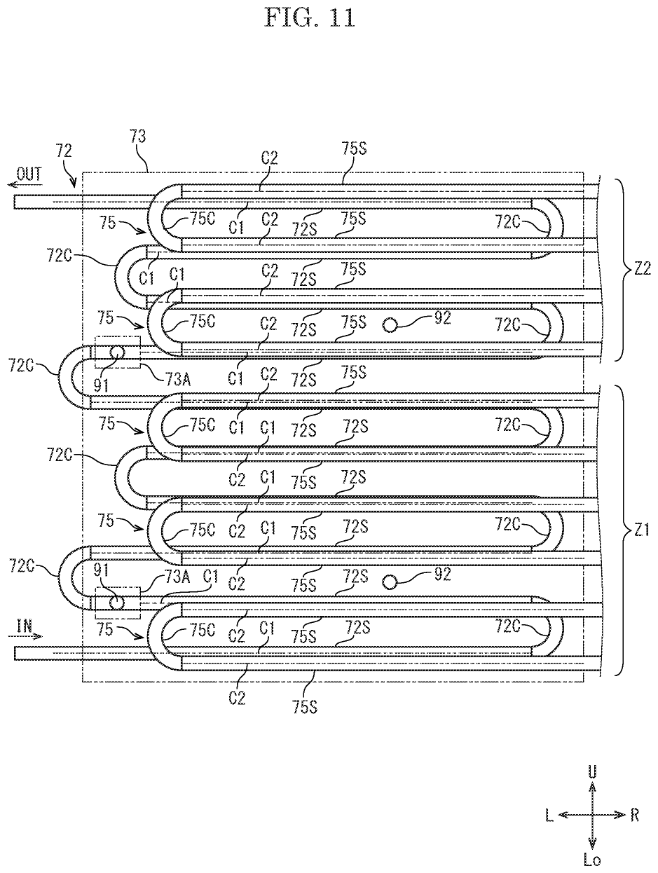

The heater 75 (see FIG. 6A, FIG. 7 and FIG. 8) is, for example, a cord heater in which an electric heating wire is coated with a silicone resin coating, and has a circular cross section. Each of the heaters 75 has two heater straight portions 75S formed into a straight shape and a heater curved portion 75C bent in a U-shape and connecting the two heater straight portions 75S (see FIG. 10), and is stored in a casing 78 made of metal, resin, or the like. The casing 78 is fixedly mounted to the metal plate 73 using an adhesive tape, an adhesive, screws, or the like (not shown). The heater straight portions 75S are provided along the pipe straight portions 72S of the pipe 72 on an opposite side to the pipe 72 with respect to the metal plate 73. The heaters 75 are connected to a power source (not shown) by a power supply line 76 in parallel.

[Heat Insulation Material] A heat insulation material 77 is provided between the casing 80 and the heaters 75. The heat insulation material 77 is, for example, made of glass wool. The heat insulation materials 77 are inserted between the casing 80 and the heaters 75 in a compressed state, and presses the heaters 75 against the metal plates 73. When the heater 75 is pressed against the metal plate 73, the metal plate 73 is pressed against the pipe 72.

[First Contact Area and Second Contact area] Next, a first contact area C1 and a second contact area C2 will be described. FIG. 11 is a plan view showing the first contact area C1 and the second contact area C2. FIG. 12 is a view schematically showing a cross section of the heater unit 71.

A linear area where the pipe straight portion 72S and the metal plate 73 are in contact with each other is defined as the first contact area C1, and a linear area where the heater straight portion 75S and the metal plate 73 are in contact with each other is defined as the second contact area C2. As shown in FIG. 11 and FIG. 12, a distance (D1 to D4 in FIG. 12) between the first contact area C1 and the second contact area C2 disposed adjacently to each other in the upper-and-lower direction (an example of a direction along a surface of the metal plate 73) is not uniform. FIG. 2 shows the second contact section C2, and in the first contact section C1, a distance between the first contact area C1 and the second contact area C2 disposed adjacently to each other in the upper-and-lower direction is not uniform. Further, a distance between the first contact area C1 and the second contact area C2 disposed adjacently to each other in the upper-and-lower direction is not uniform in the longitudinal direction (the left-and-right direction) (the example is not shown).

If there is an area where the distance between the first contact area C1 and the second contact area C2 disposed adjacently to each other in the upper-and-lower direction is zero, there is a possibility that the ink is excessively heated locally at the area, causing problems such as deterioration of the ink and excessive reduction in viscosity. Therefore, as shown in FIG. 11 and FIG. 12, the linear first contact area C1 where the pipe straight portion 72S and the metal plate 73 come into contact with each other and the linear second contact area C2 where the heater straight portion 75S and the metal plate 73 come into contact with each other are separated from each other in the direction along the surface of the metal plate 73.

On the other hand, because the ink passes through the pipe 72 in a few tens of seconds, it is necessary to apply a large amount of heat in order to increase the temperature to a predetermined temperature within the period. On the other hand, the flow rate of the ink varies depending on a density of the image to be printed. The flow of the ink is suddenly stopped or restarted. Due to these circumstances, a responsiveness of temperature increasing to the power supplying must be high. For this purpose, the distance between the first contact area C1 and the second contact area C2 disposed adjacently to each other in the upper-and-rear direction must not be too long. Therefore, the distance between the first contact area C1 and the second contact area C2 disposed adjacently to each other in the direction along the metal plate 73 is set to ⅓ or less of the distance between the first contact areas C1 disposed adjacently to each other.

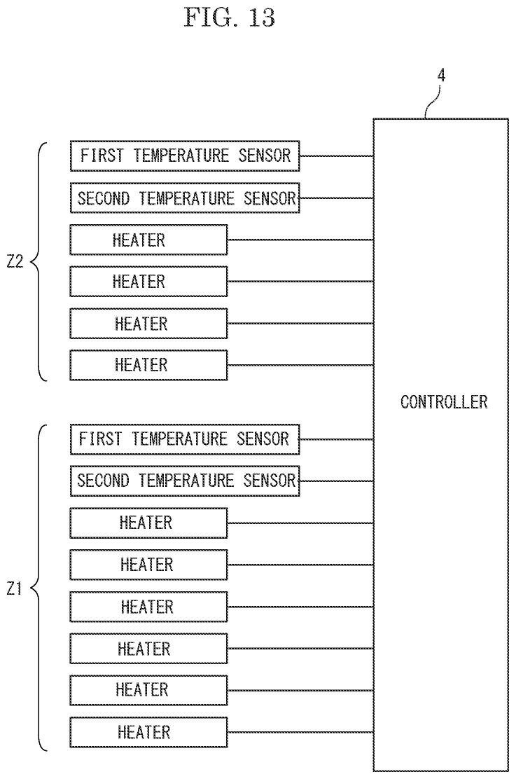

Next, an electrical configuration of the ink supply device 2 will be described. FIG. 13 is a block diagram showing the electrical configuration of the ink supply device 2.

[First Temperature Sensor, Second Temperature Sensor] A first temperature sensor 91 is provided in the pipe 72 at a portion not along the heater 75, and measures a temperature of the pipe 72. Since the temperature of the pipe 72 is approximately equal to a temperature of the ink, it can be said that the first temperature sensor 91 substantially measures the temperature of the ink. The first temperature sensor 91 is disposed separately from the heater 75 by a predetermined distance or more. The metal plate 73 has an opening 73A at a portion corresponding to the first temperature sensor 91. A second temperature sensor 92 is provided on the metal plate 73 and measures a temperature of the metal plate 73. Since the temperature of the metal plate 73 is approximately equal to a temperature of the heater 75, it can be said that the second temperature sensor 92 substantially measures the temperature of the heater 75. The heater 75, the first temperature sensor 91 and the second temperature sensor 92 are provided for each section of the pipe 72, and the heater 75 can be independently controlled for each section of the pipe 72.

[Controller] A controller 4 (see FIG. 13) is an integrated circuit in which logic circuits are integrated. The controller 4 controls the temperature of the heater 75 by changing a duty ratio of a voltage applied to the heater 75 by a drive element (not shown). The controller 4 may operate by cooperation of a processor and a software. To the controller 4, the first temperature sensor 91, the second temperature sensor 92 and the heater 75 are connected. The controller 4 controls the heater 75 by using temperatures measured by the first temperature sensor 91 and the second temperature sensor 92.

For example, the controller 4 performs a feedback-control for the power supplying to the heater 75 so that the temperature of the ink measured by the first temperature sensor 91 is maintained within a predetermined range. When the temperature of the ink measured by the first temperature sensor 91 exceeds a threshold value, the controller 4 stops the power supplying to the heater 75. The threshold value is, for example, a lower limit value of a temperature range in which a viscosity of the ink is below a proper range.

Further, the controller 4 stops the power supplying to the heater 75 when the temperature of the heater 75 measured by the second temperature sensor 92 exceeds a threshold value. The threshold value is, for example, a lower limit value of a temperature range in which a failure occurs in the heater 75 or the like.

Further, the controller 4 reduces a power supply amount or stops the power supplying to the heater 75 in the second section Z2 when the temperature of the ink increases to the predetermined temperature in the first section Z1.

Further, the controller 4 increases the temperature of the ink to a temperature corresponding to most of a temperature difference (for example, 90%) between a room temperature and the predetermined temperature in the first section Z1, and increases the temperature of the ink to the predetermined temperature in the second section Z2.

According to the heater unit 71 according to the embodiment described above, since the heater unit includes the metal plate 73, the pipe 72 coming into contact with one surface of the metal plate 73, and the linear heater 75 coming into contact with the other surface of the metal plate 73 along the pipe 72, heat is transferred from the heater 75 to the pipe 72 via the metal plate 73. Thus, even if the distance between the linear heater 75 and the pipe 72 is not uniform, it becomes possible to suppress a dispersion of a heat conductivity from the heater 75 to the pipe 72.

Further, according to the heater unit 71 according to the embodiment, the pipe 72 includes the pipe straight portions 72S formed in a straight shape, the heater 75 includes the heater straight portions 75S shaped in a straight shape, and the linier first contact area C1 where the pipe straight portion 72S and the metal plate 73 are in contact with each other and the linear second contact area C2 where the heater straight portion 75S and the metal plate 73 are in contact with each other are separated from each other in a direction along the metal plate 73, so that the ink is prevented from being excessively heated locally.

Further, according to the heater unit 71 according to the embodiment, the pipe 72 includes the plurality of pipe straight portions 72S disposed in parallel at equal intervals, and the distance between the first contact area C1 and the second contact area C2 disposed adjacently to each other along the metal plate 73 is smaller than ⅓ or less of the distance between the first contact areas C1 disposed adjacently to each other, a responsiveness of the temperature increasing to the power supplying can be improved.

When the distance between the pipe straight portions 72S is not equal and the distance between the first contact areas C1 disposed adjacently to each other is not uniform, whether the distance between the first contact area C1 and the second contact area C2 disposed adjacently to each other is ⅓ or less of the distance between the first contact areas C1 disposed adjacently to each other is considered as follows. The distance between the target first contact area C1 and the target second contact area C2 may be preferably ⅓ or less of the distance between the target first contact area C1 and the first contact portion C1 disposed adjacently to each other on a side of the target second contact area C2. Further, it may be ⅓ or less of the distance between the target first contact area C1 and each of the first contact areas C1 disposed adjacently to the target first contact area C1.

Further, the heater unit 71 according to the present embodiment includes the first temperature sensor 91 provided in the pipe 72 at a portion not along the heater 75, the opening 73A disposed in the metal plate 73 at a portion corresponding to the first temperature sensor 91 and the controller 4 which controls the heater 75 based on the temperature measured by the first temperature sensor 91, so that an influence of the temperatures of the heater 75 and the metal plate 73 on the temperature measurement of the ink can be suppressed.

Further, according to the heater unit 71 according to the present embodiment, the first temperature sensor 91 is separated from the heater 75 by a predetermined distance or more, so that an influence of the temperature of the heater 75 on the temperature measurement of the ink can be suppressed.

Further, according to the heater unit 71 according to the present embodiment, the pipe 72 includes the plurality of sections divided along the flow direction of the fluid, the heater 75 and the first temperature sensor 91 are provided for each section of the pipe 72, and the controller 4 controls the heater 75 for each section of the pipe 72 by using the temperature measured by the first temperature sensor 91, so that a control accuracy of the heater 75 can be enhanced.

For example, when the temperature of the ink increases to the predetermined temperature in the first section Z1, the controller 4 stops the power supplying or decreases the power supply amount to the heater 75 in the second section Z2. According to this control, power consumption can be suppressed. Alternatively, the controller 4 increases the temperature of the ink to a temperature corresponding to most of the temperature difference (for example, 90%) between the room temperature and the predetermined temperature in the first section Z1, and increases the temperature of the ink to the predetermined temperature in the second section Z2. According to this control, since the temperature increasing range in the second section Z2 is smaller than that in the first section Z1, the temperature in the second section Z2 can be finely adjusted.

Further, according to the heater unit 71 according to the present embodiment, since the downstream section of the plurality of sections is shorter than the upstream section, the heat capacity of the ink in the downstream section is smaller than that in the upstream section. Therefore, the temperature of the ink in the downstream section can be finely adjusted.

Further, according to the heater unit 71 according to the present embodiment, the second temperature sensor 92 is provided in the metal plate 73 and the controller 4 controls the heater 75 by using the temperatures measured by the first temperature sensor 91 and the second temperature sensor 92, so that various controls can be performed in parallel.

For example, when the temperature of the ink measured by the first temperature sensor 91 exceeds a threshold value, the controller 4 stops the power supplying to the heater 75. According to this control, it is possible to prevent the viscosity of the ink from decreasing below a proper range. Alternatively, the controller 4 stops the power supplying to the heater 75 when the temperature of the heater 75 measured by the second temperature sensor 92 exceeds the threshold value. According to this control, a failure of the heater 75 or the like can be prevented.

Further, according to the heater unit 71 according to the present embodiment, the diameter of the pipe 72 is 1 mm or more, so that the ink supply amount can be increased. In addition, he diameter of the pipe 72 is 20 mm or less, so that the responsiveness of the temperature increasing to the power supplying can be enhanced. In addition, the thickness of the metal plate 73 is 2 to 20% of the diameter of the pipe 72, so that both the suppression of deformation of the metal plate 73 and the suppression of increasing of heat capacity can be achieved. The thickness of the metal plate 73 is preferably 0.1 mm or more from the viewpoint of the suppressing of deformation.

According to the heater unit 71 according to the present embodiment, the pipe 72 and the heater 75 each has a circular cross section, so that they can be made using inexpensive material, and cost increasing can be suppressed.

Further, the heater unit 71 according to the present embodiment includes the two metal plates 73 facing each other, the pipe 72 provided between the two metal plates 73 and coming into contact with the two metal plates 73 and the plurality of linear heaters 75 coming into contact with the metal plates 73 on opposite sides to the pipe 72 with respect to the metal plates 73 disposed along the pipe 72, so that the uniformity of heating can be enhanced. Further, an efficiency of heating can be enhanced.

The heater unit 71 according to the present embodiment includes the housing 80 in which the metal plates 73, the pipe 72 and the heater 75 are stored, and the heat insulation material 77 provided between the housing 80 and the heater 75 and pressing the heater 75 against the metal plate 73, so that the heater 75 can come in contact with the metal plate 73 uniformly. Further, the metal plate 73 and the pipe 72 can be brought into uniform contact with each other.

The above embodiment may be modified as follows.

The above embodiment shows an example where the metal plates 73 and the heaters 75 are provided on the front and rear sides of the pipe 72, but the metal plate 73 and the heater 75 may be provided only on the front side or the rear side of the pipe 72.

The above embodiment shows an example where the pipe 72 is configured such that the plurality of pipe straight portions 72S are connected in series by the pipe curved portions 72C, but the pipe 72 may be configured such that the plurality of pipe straight portions 72S are disposed in parallel. For example, the ink container 61 and the plurality of pipe straight portions 72S may be connected by relay pipes branched from one pipe, the plurality of pipe straight portions 72S and the coupling 58 may be connected by relay pipes joining the plurality of pipes to one pipe, and the ink may flow in parallel through the plurality of pipe straight portions 72S.

The above embodiment shows an example of the heater 75 where the two heater straight portions 75S are connected by the heater curved portion 75C, but the heater 75 may have only the heater straight portion 75S.

The above embodiment shows an example where the pipe 72 is divided into the two sections along the flow direction of the fluid, but the pipe 72 may be divided into three or more sections.

The above embodiment shows an example where the pipe 72 and the heater 75 each has a circular cross section, but the pipe 72 and the heater 75 may have elliptical, oval, rectangular or the like cross section.

The above embodiment shows an example where the heater unit 71 heats the ink, but the heater unit 71 may be used as a device for heating a liquid other than the ink. For example, the heater unit 71 may be used to heat a treatment liquid for the base treatment of the sheet S. In addition, the heater unit 71 may be used to heat a liquid in which conductors used when an electric circuit is formed are dispersed, a luminescent material used in the manufacture of an organic EL (Electro-Luminescence) panel, a printing dye, a liquefied resin or ceramics used in the formation of a three-dimensional object by a 3D printer, or the like. The heater unit 71 may be used for heating a gas or a mixture of liquid and gas.

The present disclosure may be changed, substituted, or modified in various ways without departing from the spirit of the technical idea, and the claims include all embodiments which may be included within the scope of the technical idea.

1. A heater unit comprising:
a metal plate;
a pipe through which a fluid to be heated is passed and coming into contact with one surface of the metal plate; and
a linear heater coming into contact with the other surface of the metal plate and disposed along the pipe.

2. The heater unit according to claim 1, wherein
the pipe has a pipe straight portion formed into a straight shape,
the heater has a heater straight portion formed into a straight shape, and
a first contact area where the pipe straight portion comes into contact with the metal plate and a second contact area where the heater straight portion comes into contact with the metal plate are separated from each other in a direction along the surface of the metal plate.

3. The heater unit according to claim 2, wherein
the first contact area and the second contact area are separated from each other in a direction perpendicular to the pipe straight portion.

4. The heater unit according to claim 2, wherein
the pipe has a plurality of the pipe straight portions disposed in parallel, and
a distance between the first contact area and the second contact area disposed adjacently to each other is less than ⅓ of a distance between the first contact areas disposed adjacently to each other.

5. The heater unit according to claim 2, wherein
the pipe has a plurality of the pipe straight portions disposed in parallel, and
the pipe straight portions are disposed at qual intervals.

6. The heater unit according to claim 2, wherein
the pipe has a plurality of the pipe straight portions disposed in parallel, and
the distance between the first contact area and the second contact area disposed adjacently to each other is different for each first contact area.

7. The heater unit according to claim 1, comprising:
a first temperature sensor provided in the pipe at a portion not along the heater;
an opening provided in the metal plate at a portion corresponding to the first temperature sensor; and
a controller configured to control the heater by using a temperature measured by the first temperature sensor.

8. The heater unit according to claim 1, wherein
the first temperature sensor is separated from the heater by a predetermined distance or more.

9. The heater unit according to claim 7, wherein
the pipe contains a plurality of sections divided along a flow direction of the fluid,
the heater and the first temperature sensor are provided for each section of the pipe, and
the controller controls the heater for each section of the pipe by using a temperature measured by the first temperature sensor.

10. The heater unit according to claim 9, wherein
the section on a downstream side in the flowing direction is smaller than the section on an upstream side in the flowing direction.

11. The heater unit according to claim 7, comprising a second temperature sensor in the metal plate, wherein
the controller controls the heater by using the temperatures measured by the first temperature sensor and the second temperature sensor.

12. The heater unit according to claim 1, wherein
the metal plate has a thickness of 2 to 20% of a diameter of a circle having the same sectional area as the pipe.

13. The heater unit according to claim 1, wherein
the pipe and the heater each has a circular cross section.

14. The heater unit according to claim 1 comprising:
the two metal plate facing each other;
the pipe disposed between the metal plates and coming into contact with one surface of each metal plate; and
a plurality of the linear heaters coming into contact with the other surface of each metal plate and disposed along the pipe.

15. The heater unit according to claim 11, further comprising:
a casing in which the metal plate, the pipe and the heaters are stored; and
an insulation material disposed between the casing and the heaters and pressing the heater against the metal plate.

16. An ink supply device comprising:
an ink container in which an ink is stored; and
the heater unit according to claim 1, which heats the ink fed from the ink container.

17. An image forming system comprising:
the ink supply device according to claim 16; and
an inkjet recording apparatus which discharges the ink fed from the ink supply device and forms an image.
